(19) United States
(12) Patent Application Publication
(10) Pub. No.: US 2024/0343056 A1
(43) Pub. Date: Oct. 17, 2024

(54) Page Marker Assembly

(71) Applicant: Thomas Vanselow, Kent, WA (US)

(72) Inventor: Thomas Vanselow, Kent, WA (US)

(21) Appl. No.: 18/133,604

(22) Filed: Apr. 12, 2023

(51) Int. Cl. B42D 9/00

(52) U.S. Cl. CPC B42D 9/007

(57) ABSTRACT

A page marker assembly for marking a plurality of pages in a book includes a panel that is releasably attachable to a spine of the book. A plurality of ribbons is provided and each of the ribbons is attached to and extends away from the panel. Each of the ribbons is positionable between respective pages of the book thereby facilitating each of the plurality of ribbons to mark the respective pages for a reader.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

### Not Applicable

### BACKGROUND OF THE INVENTION

### (1) Field of the Invention

The disclosure relates to page marker devices and more particularly pertains to a new page marker device for marking multiple pages in a book. The device includes a panel and an adhesive pad bonded to the panel to facilitate the adhesive pad to adhesively engage a spine of a book. The device includes a plurality of ribbons attached to the panel thereby facilitating each of the ribbons to be positioned between respective pages of the book.

### (2) Description of Related Art Including Information Disclosed Under 37 CFR 1.97 and 1.98

The prior art relates to page marker devices including a bookmark device that includes an ovoid panel, a plurality of interlocked ribbons and a plurality of strings attached between the ovoid panel and the plurality of interlocked ribbons. The prior art discloses a multipage book marker that includes a plurality of loops that are extendable around a spine of a book, a plurality of ribbons that are positionable between respective pages of the book and a plurality of ornaments. The prior art discloses a multipage bookmark that includes a clip, a base, a clip tongue and a plurality of ribbons attached to the base. The prior art discloses a multipage bookmark device that includes an attachment member and a plurality of strings connected to the attachment member. The prior art discloses a combination writing instrument holder and bookmark which including a writing instrument holder that has a pocket for storing a writing instrument and a plurality of fabric strips attached to the writing instrument holder.

### BRIEF SUMMARY OF THE INVENTION

An embodiment of the disclosure meets the needs presented above by generally comprising a panel that is releasably attachable to a spine of a book. A plurality of ribbons is provided and each of the ribbons is attached to and extends away from the panel. Each of the ribbons is positionable between respective pages of the book thereby facilitating each of the plurality of ribbons to mark the respective pages for a reader.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a back perspective view of a page marker assembly according to an embodiment of the disclosure.

FIG. 2 is a back view of an embodiment of the disclosure.

FIG. 3 is a front view of an embodiment of the disclosure.

FIG. 4 is a perspective in-use view of an embodiment of the disclosure.

FIG. 5 is a perspective alternative in-use view of an embodiment of the disclosure.

### DETAILED DESCRIPTION OF THE INVENTION

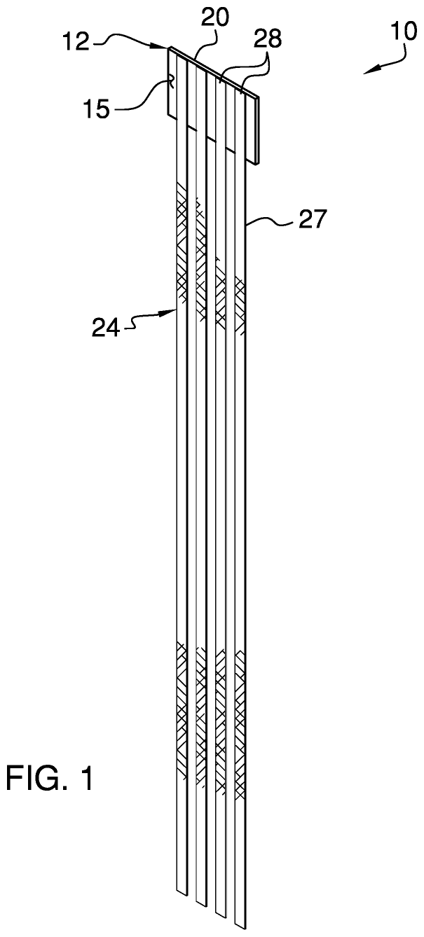

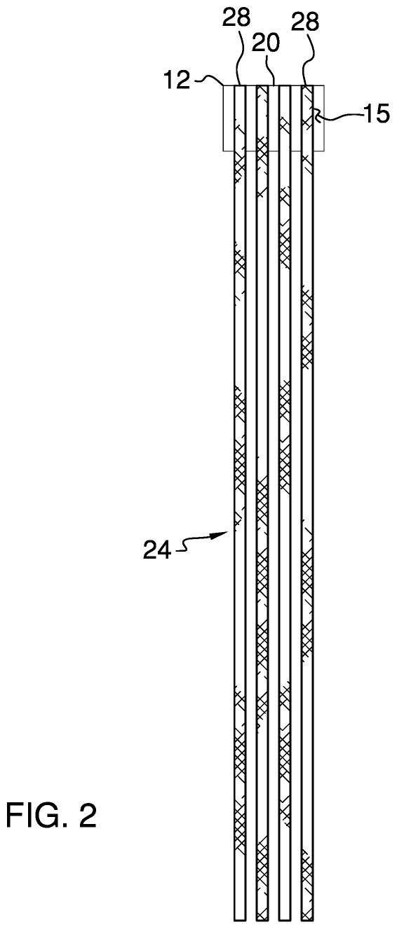

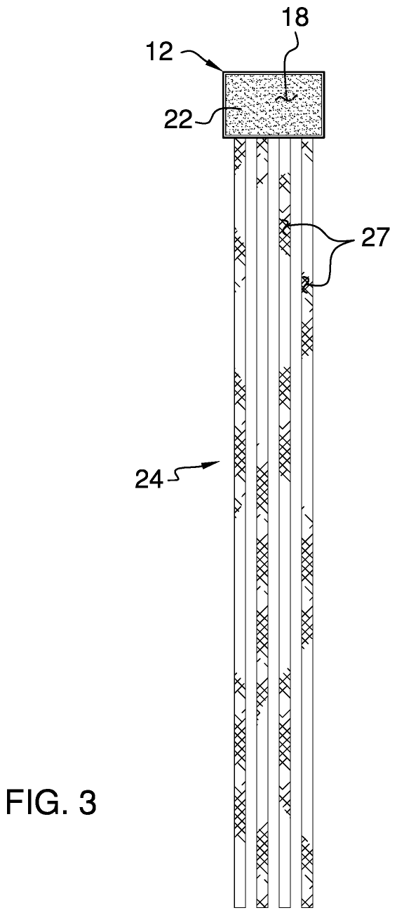

With reference now to the drawings, and in particular to FIGS. 1 through 5 thereof, a new page marker device embodying the principles and concepts of an embodiment of the disclosure and generally designated by the reference numeral 10 will be described.

As best illustrated in FIGS. 1 through 5, the page marker assembly 10 generally comprises a panel 12 that is releasably attachable to a spine 14 of a book 16. The book 16 may be a printed book of any conventional design, including hard cover books and soft cover books. The panel 12 has a front surface 18, a back surface 15 and an upper edge 20 and the panel 12 is comprised of a deformable material thereby facilitating the panel 12 to conform to curvature of the spine 14 of the book 16. An adhesive pad 22 is provided and the adhesive pad 22 is bonded to the front surface 18 of the panel 12. The adhesive pad 22 adhesively engages the spine 14 when the panel 12 is applied to the spine 14 for retaining the panel 12 on the spine 14. Furthermore, the adhesive pad 22 may comprise of a non-residual, multiple use adhesive such that the adhesive pad 22 can be repeatedly applied to a large number of books. The panel 12 has a bottom edge 17, a first lateral edge 19 and a second lateral edge 21 that intersect each other at a perpendicular angle such that the panel 12 has a rectangular shape.

A plurality of ribbons 24 is provided and each of the ribbons 24 is attached to and extends away from the panel 12. Each of the ribbons 24 is positionable between respective pages 26 of the book 16 to mark the respective pages 26 for a reader. Each of the ribbons 24 has a forward surface 27 and a coupled end 28. The forward surface is bonded to the back surface 15 of the panel such that the coupled end 28 of each of the ribbons 24 is aligned with the upper edge 20 of the panel 12. Furthermore, the ribbons 24 are spaced apart from each other and are distributed along the back surface 15. Additionally, each of the ribbons 24 has a unique color with respect to each other thereby facilitating each of the ribbons 24 to be visually distinguished from each other. Each of the ribbons 24 may have a length of at least 35.0 cm and each of the ribbons 24 may be comprised of deformable material, including but not being limited to, plastic or silk or nylon.

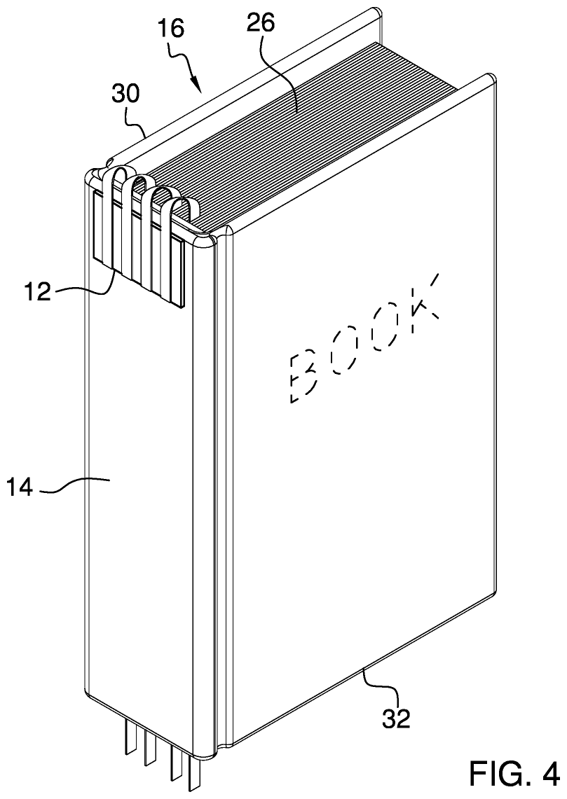

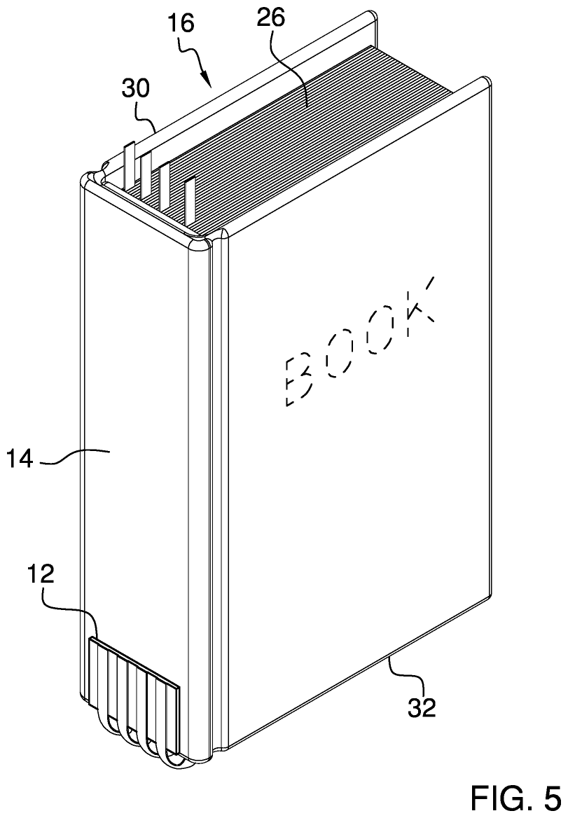

In use, as is most clearly shown in FIG. 4, the panel 12 is positioned on the spine 14 of the book 16 at a point located adjacent to a top end 30 of the book 16 such that the adhesive pad 22 adheres to the spine 14. Each of the ribbons 24 can be positioned between respective pages 26 of the book 16 thereby marking the respective pages 26 having the ribbons 24 extending outwardly beyond a bottom end 32 of the book 16. Furthermore, the ribbons 24 can be trimmed, if necessary, to facilitate the ribbons 24 to extend no more than 5.0 cm away from the book 16. As is most clearly shown in FIG. 5, the panel 12 can be positioned on the spine 14 of the book 16 at a point located adjacent to the bottom end 32 of the book 16. In this way the ribbons 24 extend outwardly from the top end 30 of the book 16 thereby inhibiting the ribbons 24 from becoming soiled or damaged when the book 16 is stood upon its bottom end 32 and slid into or out of a bookshelf. Additionally, the ribbons 24 extending between the respective pages 26 are easily visible as they extend outwardly beyond the top end of the book 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A page marker assembly for marking a plurality of pages in a book, said assembly comprising:
a panel being releasably attachable to a spine of a book; and
a plurality of ribbons, each of said ribbons being attached to and extending away from said panel, each of said ribbons being positionable between respective pages of said book wherein each of said plurality of ribbons is configured to mark said respective pages for a reader.

2. The assembly according to claim 1, wherein:
said panel has a front surface, a back surface and an upper edge, said panel being comprised of a deformable material thereby facilitating said panel to conform to curvature of said spine of said book; and
said assembly includes an adhesive pad being bonded to said front surface of said panel, said adhesive pad adhesively engaging said spine when said panel is applied to said spine for retaining said panel on said spine.

3. The assembly according to claim 2, wherein each of said ribbons has a forward surface and a coupled end, said forward surface being bonded to said back surface of said panel having said coupled end of each of said ribbons being aligned with said upper edge of said panel, said plurality of ribbons being spaced apart from each other and being distributed along said back surface of said panel.

4. The assembly according to claim 1, wherein each of said ribbons has a unique color with respect to each other thereby facilitating each of said ribbons to be visually distinguished from each other.

5. A page marker assembly for marking a plurality of pages in a book, said assembly comprising:
a panel being releasably attachable to a spine of a book, said panel having a front surface, a back surface and an upper edge, said panel being comprised of a deformable material thereby facilitating said panel to conform to curvature of said spine of said book;
an adhesive pad being bonded to said front surface of said panel, said adhesive pad adhesively engaging said spine when said panel is applied to said spine for retaining said panel on said spine; and
a plurality of ribbons, each of said ribbons being attached to and extending away from said panel, each of said ribbons being positionable between respective pages of said book wherein each of said plurality of ribbons is configured to mark said respective pages for a reader, each of said ribbons having a forward surface and a coupled end, said forward surface being bonded to said back surface of said panel having said coupled end of each of said ribbons being aligned with said upper edge of said panel, said plurality of ribbons being spaced apart from each other and being distributed along said back surface of said panel, each of said ribbons having a unique color with respect to each other thereby facilitating each of said ribbons to be visually distinguished from each other.

6. A method of marking a plurality of pages in a book, the steps of the method comprising:
providing a book having a spine and a plurality of pages;
providing a panel having a front surface and a top edge;
providing an adhesive pad being bonded to said front surface of said panel;
providing a plurality of ribbons each being attached to said top edge of said panel;
positioning said panel on said spine such that said adhesive pad adhesively engages said spine; and
positioning each of said plurality of ribbons between respective pages for marking said respective pages.
